(19) United States
(12) Patent Application Publication
(10) Pub. No.: US 2018/0065087 A1
(43) Pub. Date: Mar. 8, 2018

(54) SCR CATALYST

(71) Applicant: TOYOTA JIDOSHA KABUSHIKI KAISHA, Toyota-shi (JP)

(72) Inventor: Tomoyuki MIZUNO, Miyoshi-shi (JP)

(73) Assignee: TOYOTA JIDOSHA KABUSHIKI KAISHA, Toyota-shi (JP)

(21) Appl. No.: 15/685,610

(22) Filed: Aug. 24, 2017

(30) Foreign Application Priority Data
Sep. 8, 2016 (JP) 2016-175775

(51) Int. Cl. B01D 53/94; B01J 29/85; F01N 3/08; B01J 29/06; C01B 39/54; C01B 39/02

(52) U.S. Cl. CPC B01D 53/9418; B01J 29/85; C01B 39/02; B01J 29/06; C01B 39/54; F01N 3/08

(57) ABSTRACT

A highly practical SCR catalyst excellent in NOₓ purification performance is provided. The SCR catalyst includes a blend of an aluminosilicate molecular sieve that has supported thereon copper as an extra-framework metal and that has a CHA framework, and a silicoaluminophosphate molecular sieve that has a CHA framework, and is adapted to perform selective catalytic reduction of NOₓ. In the SCR catalyst, the silicoaluminophosphate molecular sieve and the aluminosilicate molecular sieve contain silicoaluminophosphate and aluminosilicate, respectively, in a molar ratio of silicoaluminophosphate:aluminosilicate of 0.1:1.0 to 0.4:1.0.

### CROSS REFERENCE TO RELATED APPLICATIONS

The present application claims priority from Japanese patent application JP 2016-175775, filed on Sep. 8, 2016, the content of which is hereby incorporated by reference into this application.

### BACKGROUND

### Technical Field

The present disclosure relates to an SCR catalyst adapted to perform selective catalytic reduction of NOₓ in an exhaust gas.

### Background Art

In a variety of industries, a variety of attempts has been made worldwide to reduce environmental impacts and burdens. In particular, in the automobile industry, development for promoting the spread of not only fuel-efficient gasoline engine vehicles, but also so-called eco-friendly vehicles, such as hybrid vehicles and electric vehicles, as well as for further improving the performance of such vehicles has been advanced day by day.

In addition to the development of such eco-friendly vehicles, research about exhaust gas purifying catalysts for purifying exhaust gas discharged from an engine has also been actively conducted. Examples of the exhaust gas purifying catalysts include an oxidation catalyst, a three-way catalyst, an NOₓ storage-reduction catalyst, and an NOₓ selective reduction catalyst (SCR (selective catalytic reduction) catalyst).

The aforementioned SCR catalyst includes zeolites and other molecular sieves. Each of the molecular sieves is in a crystalline or a pseudo-crystalline structure having a framework that is formed by molecular tetrahedral cells interconnected in a regular manner.

Examples of the framework of the molecular sieves of the SCR catalyst include framework type codes CHA, BEA, and MOR. The catalyst performance of the molecular sieves is improved through, for example, a cationic exchange process in which a portion of ionic species existing within the framework is replaced with transition metal cations, such as Cu²⁺.

Examples of components to be removed from a lean burn exhaust gas include NOₓ, such as NO, NO₂, and N₂O. A typical selective catalytic reduction process involves the conversion of NOₓ into N₂ and H₂O in the presence of a catalyst and with the aid of a reductant.

In the reduction process, a gaseous reductant such as ammonia is added to an exhaust gas prior to bringing the exhaust gas into contact with an SCR catalyst. At this time, the reductant is absorbed onto the catalyst and NOₓ reduction reaction takes place as the gases pass through a catalyzed substrate.

Herein, Patent Document 1 discloses a catalyst composition that includes a blend of an aluminosilicate molecular sieve having a CHA framework and a silicoaluminophosphate molecular sieve having a CHA framework.

More specifically, the aluminosilicate molecular sieve and the silicoaluminophosphate molecular sieve are present in a molar ratio of aluminosilicate:silicoaluminophosphate of about 0.8:1.0 to about 1.2:1.0. Further, the aluminosilicate molecular sieve and the silicoaluminophosphate molecular sieve contain a first extra-framework metal and a second extra-framework metal, respectively, and the first and the second extra-framework metals are independently selected from the group consisting of cesium, copper, nickel, zinc, iron, tin, tungsten, molybdenum, cobalt, bismuth, titanium, zirconium, antimony, manganese, chromium, vanadium, niobium, and combinations thereof. An about 2 to 4 wt % first extra-framework metal, based on the weight of aluminosilicate, is present in the molecular sieve and the weight ratio of first extra-framework metal:second extra-framework metal is about 0.4:1.0 to about 1.5:1.0.

### RELATED ART DOCUMENTS

### Patent Documents

Patent Document 1: JP 2015-510448 A

### SUMMARY

In the catalyst composition disclosed in Patent Document 1, the molar proportion of silicoaluminophosphate is relatively high. Specifically, the silicoaluminophosphate molecular sieve and the aluminosilicate molecular sieve can be expressed as being present in a molar ratio of silicoaluminophosphate:aluminosilicate of 1.0:1.2 to 1.0:0.8 and in a molar proportion of silicoaluminophosphate/aluminosilicate of 0.83 to 1.25. Since silicoaluminophosphate is likely to deteriorate due to water adsorption and desorption, there is a problem in that a catalyst composition including silicoaluminophosphate in a higher molar proportion, that is, a catalyst composition mainly including silicoaluminophosphate can hardly be suitable for practical use.

The present disclosure has been made in view of the aforementioned problem, and provides a highly practical SCR catalyst excellent in NOₓ purification performance.

According to an embodiment of the present disclosure, there is provided an SCR catalyst adapted to perform selective catalytic reduction of NOₓ, including a blend of an aluminosilicate molecular sieve that supports thereon copper as an extra-framework metal and that has a CHA framework and a silicoaluminophosphate molecular sieve that has a CHA framework. In the SCR catalyst, the silicoaluminophosphate molecular sieve and the aluminosilicate molecular sieve contain silicoaluminophosphate and aluminosilicate, respectively, in a molar ratio of silicoaluminophosphate:aluminosilicate of 0.1:1.0 to 0.4:1.0.

In the SCR catalyst of the present disclosure, the aluminosilicate molecular sieve with a CHA framework has copper supported thereon, and the molar ratio of silicoaluminophosphate relative to aluminosilicate is significantly reduced as compared to that of the catalyst composition disclosed in Patent Document 1.

Specifically, the molar ratio of silicoaluminophosphate:aluminosilicate is 0.1:1.0 to 0.4:1.0. The molar proportion of silicoaluminophosphate/aluminosilicate is expressed as 0.1 to 0.4. This is nearly 30% or lower of a molar proportion of 0.83 to 1.25 of the catalyst composition disclosed in Patent Document 1.

When an aluminosilicate molecular sieve that has copper supported thereon (for example, a copper ion-exchanged zeolite, such as Cu-SSZ) is exposed to high temperature, copper oxide particles are formed so that oxidation of ammonia is increased, and as a result, NOₓ purification performance is lowered.

In contrast, in the SCR catalyst of the present disclosure, copper oxide particles are captured by the silicoaluminophosphate molecular sieve (for example, a proton-type zeolite, such as H-SAPO) to suppress the formation of copper oxide particles, so that oxidation of ammonia can be suppressed, and as a result, the NOₓ purification performance can be improved.

Accordingly, in the SCR catalyst of the present disclosure, the number of mole of silicoaluminophosphate is reduced as much as possible so as to set the molar ratio of silicoaluminophosphate:aluminosilicate to 0.1:1.0 to 0.4:1.0, such that the silicoaluminophosphate serves as an auxiliary material for trapping copper oxide particles, and not a main material of the SCR catalyst therefor. This suppresses deterioration of the SCR catalyst due to water adsorption and desorption, thereby making it a highly practical SCR catalyst.

Further, in another embodiment of the SCR catalyst according to the present disclosure, the mass ratio of the extra-framework metals of the aluminosilicate molecular sieve and the silicoaluminophosphate molecular sieve is 1.0:0.0 to 1.0:1.0.

The SCR catalyst of the present embodiment ranges from an SCR catalyst in which the silicoaluminophosphate molecular sieve has no extra-framework metal (the mass ratio of extra-framework metal of aluminosilicate molecular sieve:extra-framework metal of silicoaluminophosphate molecular sieve is 1.0:0.0) to an SCR catalyst in which the extra-framework metals of the aluminosilicate molecular sieve and the silicoaluminophosphate molecular sieve are contained in the same mass ratio (the mass ratio is 1.0:1.0). Therefore, the CSR catalyst of the present embodiment significantly differs from the catalyst composition described in Patent Document 1 also in terms of the mass ratio of extra-framework metals.

As understood from the aforementioned description, according to the SCR catalyst of the present disclosure, since the silicoaluminophosphate molecular sieve and the aluminosilicate molecular sieve contain silicoaluminophosphate and aluminosilicate, respectively, in a molar ratio of silicoaluminophosphate:aluminosilicate of 0.1:1.0 to 0.4:1.0, the SCR catalyst is excellent in NOₓ purification performance and highly practical.

### BRIEF DESCRIPTION OF THE DRAWINGS

FIG. 1 is a graph that shows results of an experiment for verifying the relation between the molar proportion of silicoaluminophosphat/aluminosilicate and the NOₓ purification rate at an evaluation temperature of 450° C.;

FIG. 2 is a graph that shows results of the experiment for verifying the relation between the molar proportion of silicoaluminophosphat/aluminosilicate and the NOₓ purification rate at an evaluation temperature of 410° C.;

FIG. 3 is a graph that shows results of the experiment for verifying the relation between the molar proportion of silicoaluminophosphat/aluminosilicate and the NOₓ purification rate at an evaluation temperature of 330° C.;

FIG. 4 is a graph that shows results of an experiment for verifying the relation between a catalyst coating amount and catalyst performance; and

FIG. 5 is a graph that shows results of an experiment for verifying the relation between a catalyst coating amount and a pressure loss.

### DETAILED DESCRIPTION

### (Embodiment of the SCR Catalyst)

The SCR catalyst of the present disclosure includes a catalyst layer that contains a blend of an aluminosilicate molecular sieve that supports thereon copper as an extra-framework metal and has a CHA framework and a silicoaluminophosphate molecular sieve that has a CHA framework, and a substrate. The catalyst layer is formed on a cell wall surface of the substrate so as to form the overall structure of the SCR catalyst.

The SCR catalyst is provided in an exhaust gas purification system (not shown). The exhaust gas purification system includes, for example, an internal combustion engine that discharges exhaust gas, a diesel oxygen catalyst (DOC), a diesel particulate filter (DPF), an urea tank that supplies an exhaust path with urea water, the SCR catalyst, and an ammonia slip catalyst (ASC).

The substrate of the SCR catalyst is a carrier with a honeycomb structure capable of supporting the catalyst layer, and is made of ceramics, SiC, metal, and the like.

Further, the aluminosilicate molecular sieve of the catalyst layer that has supported thereon copper as an extra-framework metal and has a CHA framework is a copper ion-exchanged zeolite, such as Cu-SSZ13 and Cu-SSZ62, and the silicoaluminophosphate molecular sieve that has a CHA framework is a proton-type zeolite, such as H-SAPO34, H-SAPO44, and H-SAPO47.

Herein, the silicoaluminophosphate molecular sieve and the aluminosilicate molecular sieve contain silicoaluminophosphate and aluminosilicate, respectively, in a molar ratio of silicoaluminophosphate:aluminosilicate of 0.1:1.0 to 0.4:1.0 (which is represented as a molar proportion of silicoaluminophosphate/aluminosilicate of 0.1 to 0.4).

Furthermore, the aluminosilicate molecular sieve has supported thereon Cu as the extra-framework metal, while the silicoaluminophosphate molecular sieve does not have an extra-framework metal supported thereon.

When an aluminosilicate molecular sieve that has copper supported thereon is exposed to high temperature, copper oxide particles are formed so that oxidation of ammonia is increased, and as a result, NOₓ purification performance is lowered. In contrast, in the SCR catalyst of the present disclosure, copper oxide particles are captured by the silicoaluminophosphate molecular sieve to suppress the formation of copper oxide particles, so that oxidation of ammonia can be suppressed, and as a result, the NOₓ purification performance can be improved.

In the SCR catalyst of the present disclosure, the number of moles of silicoaluminophosphate is reduced as much as possible so as to set the molar ratio of silicoaluminophosphate:aluminosilicate to 0.1:1.0 to 0.4:1.0, such that the silicoaluminophosphate serves as an auxiliary material for trapping copper oxide particles. This effectively suppresses deterioration of the SCR catalyst due to water adsorption and desorption, thereby making it a highly practical SCR catalyst.

### (Results of an Experiment for Verifying the Relation Between the Molar Proportion of Silicoaluminophosphat/Aluminosilicate and the NOₓ Purification Rate)

The present inventors produced, through the following process, an SCR catalyst test sample with variations of the molar proportion of silicoaluminophosphate/aluminosilicate shown in Table 1 below, and conducted an experiment for verifying the NOₓ purification rate of the sample at evaluation temperatures of 450° C., 410° C., and 330° C.

Herein, the SCR catalyst test sample was produced through the following process: Cu-SSZ13 was prepared so as to contain 3.0 mass % Cu and have a molar ratio of Si:Al of 13:2, and H-SAPO34 was prepared so as to have a molar ratio of Si:Al:P of 17:50:33. The catalyst was prepared through the following process: the Cu-SSZ13 and H-SAPO34, SiO₂ sol, and H₂O were mixed and agitated so as to form slurry, which was then applied to a cordierite honeycomb substrate, dried at 150° C., and baked at 550° C. for two hours in the air, and the SCR catalyst test sample was thus produced.

In this experiment, a catalyst with a volume of 15 cc was cut out to be used as the test sample, and a transient evaluation of simulated SCR reaction of the test sample was conducted using a model gas evaluation apparatus. Herein, the composition of gas in each of rich and lean states is shown in Table 2 below. The state of gas was switched between rich and lean states with 10 seconds for the rich state and 60 seconds for the lean state, and the space velocity (SV) was 85700 (1/h).

TABLE 1

| | | SAPO/SSZ | SAPO/SSZ |
|---|---|---|---|
| | | proportion | proportion |
| Cu-SSZ13 | H-SAPO34 | (mass ratio) | (molar ratio) |
| (g/L) | (g/L) | (—) | (—) |
| 150 | 0 | 0.00 | 0.00 |
| 144 | 6 | 0.04 | 0.04 |
| 136 | 14 | 0.10 | 0.10 |
| 125 | 25 | 0.20 | 0.20 |
| 107 | 43 | 0.40 | 0.41 |
| 100 | 50 | 0.50 | 0.51 |
| 90 | 60 | 0.67 | 0.68 |

Note:
g/L represents each of the masses of Cu-SSZ13 and H-SAPO34 per catalyst with a volume of one litter.

TABLE 2

| | O₂ | NO | NH₃ | H₂O |
|---|---|---|---|---|
| | (%) | (ppm) | (ppm) | (%) |
| Rich | 0 | 150 | 550 | 5 |
| Lean | 10 | 50 | 0 | 5 |

The results of the experiment are shown in FIGS. 1 to 3. Herein, FIGS. 1 to 3 show the results of the experiment for verifying the relation between the molar proportion of silicoaluminophosphat/aluminosilicate and the NOₓ purification rate at evaluation temperatures of 450° C., 410° C., and 330° C., respectively. Each of FIGS. 1 to 3 shows an approximate curve representing plots of the results of the experiment.

It can be understood from FIG. 1 showing the results of the experiment at an evaluation temperature of 450° C. that with SAPO/SSZ molar proportions of 0.1 and 0.4, inflection points appear; with a SAPO/SSZ molar proportion in the range of 0.1 to 0.4, high NOₓ purification performance with a NOₓ purification rate of 60% or higher is exhibited; and that with a SAPO/SSZ molar proportion of less than 0.1 or greater than 0.4, the NOₓ purification rate significantly decreases.

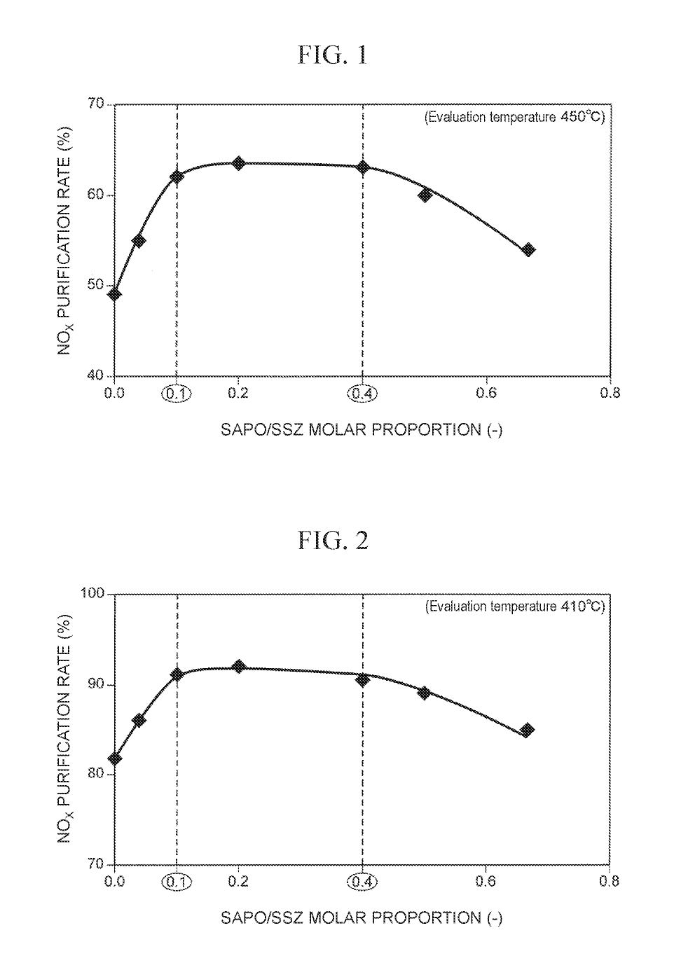

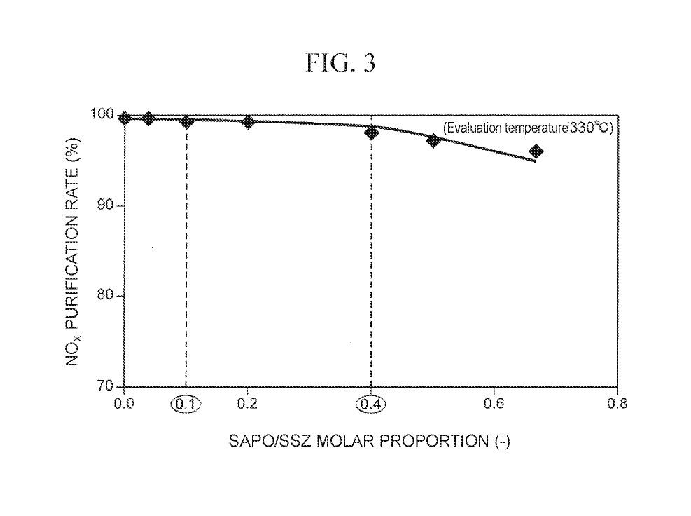

Further, FIG. 2 showing the results of the experiment at an evaluation temperature of 410° C. shows a tendency similar to that of FIG. 1. It can be understood from FIG. 2 that with SAPO/SSZ molar proportions of 0.1 and 0.4, inflection points appear; with a SAPO/SSZ molar proportion in the range of 0.1 to 0.4, quite high NOₓ purification performance with an NOₓ purification rate of 90% or higher is exhibited; and that with a SAPO/SSZ molar proportion of less than 0.1 or greater than 0.4, the NOₓ purification rate decreases.

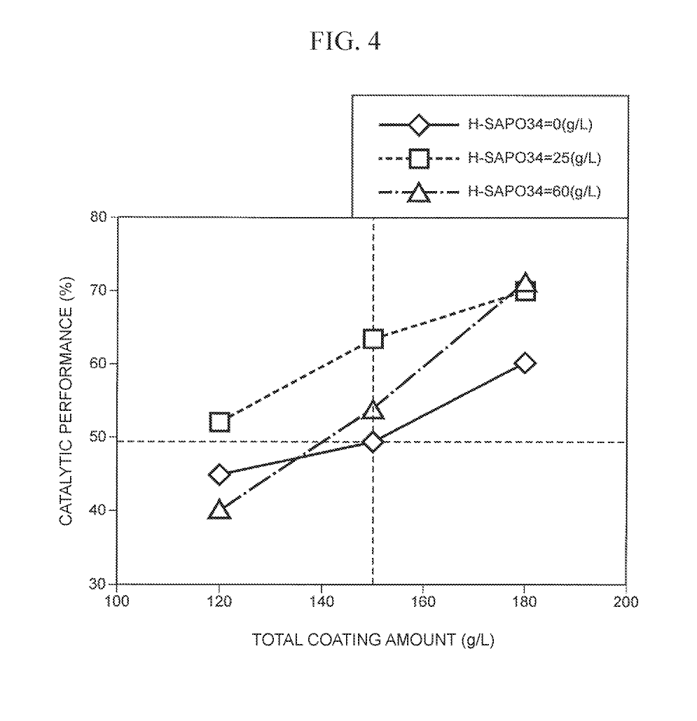

Furthermore, it can be understood from FIG. 3 showing the results of the experiment at an evaluation temperature of 330° C. that with a SAPO/SSZ molar proportion of greater than 0.4, the NOₓ purification rate gradually decreases.

It can be understood from each of FIGS. 1 to 3 that at an evaluation temperature of 450° C., with a SAPO/SSZ molar proportion in the range of 0.1 to 0.4, a higher NOₓ purification rate was exhibited as compared to that with a SAPO/SSZ molar proportion in other ranges. It is considered that this is because with a SAPO/SSZ molar proportion in the range of 0.1 to 0.4, copper oxide particles are captured by SAPO so as to become innoxious when catalyst performance is exhibited.

Based on the results of the experiment, the SCR catalyst of the present disclosure was defined such that the silicoaluminophosphate molecular sieve and the aluminosilicate molecular sieve contain silicoaluminophosphate and aluminosilicate, respectively, in a molar ratio of silicoaluminophosphate:aluminosilicate of 0.1:1.0 to 0.4:1.0 (which is represented as a molar proportion of silicoaluminophosphate/aluminosilicate of 0.1 to 0.4).

### (Results of Experiments for Verifying the Relations Between a Catalyst Coating Amount and Catalyst Performance and Between a Catalyst Coating Amount and a Pressure Loss)

The present inventors further conducted experiments for verifying the relations between a catalyst coating amount and catalyst performance and between a catalyst coating amount and a pressure loss with variations of the masses of the aluminosilicate molecular sieve and the silicoaluminophosphate molecular sieve and the catalyst coating amount, as shown in Table 3 below.

In the experiments, the gas shown in Table 4 below was circulated for five hours at a temperature of 800° C. The state of the gas was switched between rich and lean states with 10 seconds for the rich state and 60 seconds for the lean state, and the space velocity SV was 114000 (1/h).

TABLE 3

| Cu-SSZ13 | H-SAPO34 | Total coating amount |
|---|---|---|
| (g/L) | (g/L) | (g/L) |
| 120 | 0 | 120 |
| 95 | 25 | |
| 60 | 60 | |
| 150 | 0 | 150 |
| 125 | 25 | |
| 90 | 60 | |
| 180 | 0 | 180 |
| 155 | 25 | |
| 120 | 60 | |

TABLE 4

| | O₂ | CO | H₂O |
|---|---|---|---|
| | (%) | (%) | (%) |
| Rich | 0 | 2 | 10 |
| Lean | 10 | 0 | 10 |

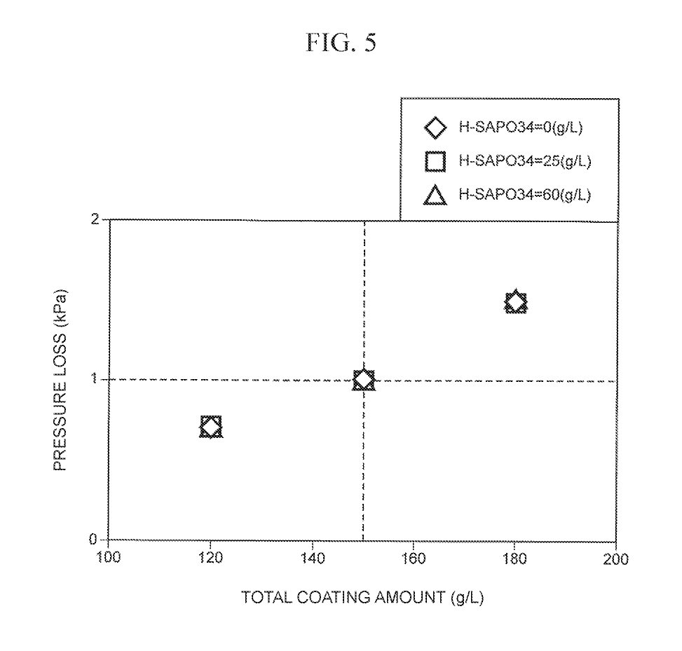

The results of the experiments are shown in FIGS. 4 and 5. Herein, FIG. 4 shows the results of the experiment for verifying the relation between a catalyst coating amount and catalyst performance, and FIG. 5 shows the results of the experiment for verifying the relation between a catalyst coating amount and a pressure loss.

It can be understood from FIG. 4 that the catalysts containing H-SAP034 with total coating amounts of 150 g/L and 180 g/L exhibit high catalyst performance.

In addition, it can be understood from FIG. 5 that with a greater total coating amount, the pressure loss of the catalyst increases.

In view of the results shown in FIGS. 4 and 5, it is considered that with a total coating amount of 150 g/L or greater and replacement of a portion of Cu-SSZ with H-SAP034, the increase in the pressure loss is suppressed so that the catalyst performance is improved.

Although the embodiments of the present disclosure have been described in detail with reference to the drawings, specific structures are not limited thereto, and any design changes that may occur within the spirit and scope of the present disclosure are all included in the present disclosure.

What is claimed is:

1. An SCR catalyst adapted to perform selective catalytic reduction of NOₓ, comprising a blend of an aluminosilicate molecular sieve having supported thereon copper as an extra-framework metal and having a CHA framework, and a silicoaluminophosphate molecular sieve having a CHA framework,
wherein the silicoaluminophosphate molecular sieve and the aluminosilicate molecular sieve contain silicoaluminophosphate and aluminosilicate, respectively, in a molar ratio of silicoaluminophosphate:aluminosilicate of 0.1:1.0 to 0.4:1.0.

2. The SCR catalyst according to claim 1, wherein a mass ratio of the extra-framework metal of the aluminosilicate molecular sieve to that of the silicoaluminophosphate molecular sieve is 1.0:0.0 to 1.0:1.0.
